(19) United States
(12) Patent Application Publication
(10) Pub. No.: US 2023/0281835 A1
(43) Pub. Date: Sep. 7, 2023

(54) WIDE ANGLE EYE TRACKING

(71) Applicant: QUALCOMM Incorporated, San Diego, CA (US)

(72) Inventors: Russell GRUHLKE, San Jose, CA (US); Kebin (Kirby) LI, Fremont, CA (US)

(21) Appl. No.: 17/686,336

(22) Filed: Mar. 3, 2022

(51) Int. Cl. G06T 7/292; G06T 7/70; G06V 40/19

(52) U.S. Cl. CPC G06T 7/292; G06T 7/70; G06V 40/19; G02B 27/0172

(57) ABSTRACT

Systems and techniques are provided for eye imaging. For example, an eye tracking apparatus can include a first plurality of eye tracking components comprising a first illumination source, a first image sensor, and a first light directing component associated with a first field of view. The apparatus can include a second plurality of eye tracking components comprising a second illumination source, a second image sensor, and a second light directing component associated with a second field of view, wherein at least a portion of the first field of view is different from at least a portion of the second field of view. The apparatus can include a display and a lens assembly including a first lens between a first object and the display and a second lens between a second object and the display.

### FIELD

The present disclosure generally relates to optical systems. In some examples, aspects of the present disclosure are related to optical systems and techniques for eye imaging.

### BACKGROUND

An extended reality (XR) device is a device that displays an environment to a user, for example through a head-mounted display (HMD) or other device. The environment is at least partially different from the real-world environment in which the user is in. The user can generally change their view of the environment interactively, for example by tilting or moving the HMD or other device. Virtual reality (VR) and augmented reality (AR) are examples of XR.

In some cases, an XR system can include a “see-through” display that allows the user to see their real-world environment based on light from the real-world environment passing through the display. In some cases, an XR system can include a “pass-through” display that allows the user to see their real-world environment, or a virtual environment based on their real-world environment, based on a view of the environment being captured by one or more cameras and displayed on the display. “See-through” or “pass-through” XR systems can be worn by users while the users are engaged in activities in their real-world environment.

In some cases, the XR system can include an eye imaging (also referred to herein as gaze detection) system. In some cases, eyes of the user of an XR system can move over a large range of offset and/or rotation. In some cases, the eyes of a user of an XR system can have different alignment relative to the display.

### BRIEF SUMMARY

In some examples, systems and techniques are described for performing eye tracking. According to at least one illustrative example, a method is provided for eye tracking. The method includes: obtaining a first image associated with a first object from a first image sensor associated with a first field of view; obtaining a second image associated with a second object from a second image sensor associated with a second field of view at least partially different from the first field of view; and determining a position, rotation, or both of the first object and the second object based on at least one of the first image obtained from the first image sensor and the second image obtained from the second image sensor. In some cases, the first field of view is associated with a first illumination source, the first image sensor, and a first light directing component; the first light directing component is disposed between the first object and a display and oriented along a first axis, wherein the first axis is parallel to a surface of a first lens facing the first object, the first lens included in a lens assembly; the second field of view is associated with a second illumination source, the second image sensor, and a second light directing component; the second light directing component is disposed between the second object and the display and oriented along a second axis, wherein the second axis is parallel to a surface of a second lens facing the second object, and wherein an orientation of the first axis is different from an orientation of the second axis; the first lens is included in a lens assembly and disposed between a display and the first object; and the second lens is included in the lens assembly and disposed between the display and the second object.

In another example, an apparatus for eye tracking is provided that includes a first plurality of eye tracking components comprising a first illumination source, a first image sensor, and a first light directing component associated with a first field of view; a second plurality of eye tracking components comprising a second illumination source, a second image sensor, and a second light directing component associated with a second field of view, wherein at least a portion of the first field of view is different from at least a portion of the second field of view; a display; and a lens assembly including a first lens between a first object and the display and a second lens between a second object and the display; wherein: the first light directing component is disposed between the first object and the display and oriented along a first axis, wherein the first axis is parallel to a surface of the first lens facing the first object; and the second light directing component is disposed between the second object and the display and oriented along a second axis, wherein the second axis is parallel to a surface of the second lens facing the second object, and wherein an orientation of the first axis is different from an orientation of the second axis.

In another example, a non-transitory computer-readable medium is provided that has stored thereon instructions that, when executed by one or more processors, cause the one or more processors to: obtain a first image associated with a first object from a first image sensor associated with a first field of view; obtain a second image associated with a second object from a second image sensor associated with a second field of view at least partially different from the first field of view, wherein the second field of view is associated with a second illumination source, the second image sensor, and a second light directing component; and determine a position, rotation, or both of the first object and the second object based on at least one of the first image obtained from the first image sensor and the second image obtained from the second image sensor.

In another example, an apparatus for eye tracking is provided. The apparatus includes: means for obtaining a first image associated with a first object from a first image sensor associated with a first field of view; means for obtaining a second image associated with a second object from a second image sensor associated with a second field of view at least partially different from the first field of view, wherein the second field of view is associated with a second illumination source, the second image sensor, and a second light directing component; and means for determining a position, rotation, or both of the first object and the second object based on at least one of the first image obtained from the first image sensor and the second image obtained from the second image sensor.

In some aspects, one or more of the apparatuses described above is, is part of, or includes a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, a vehicle (e.g., a computing device of a vehicle), or other device. In some aspects, an apparatus includes a camera or multiple cameras for capturing one or more images. In some aspects, the apparatus includes a display for displaying one or more images, notifications, and/or other displayable data. In some aspects, the apparatus can include one or more sensors. In some cases, the one or more sensors can be used for determining a location and/or pose of the apparatus, a state of the apparatuses, and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1A is a cross-sectional diagram of a lens assembly including eye tracking, in accordance with some examples of the present disclosure;

FIG. 1B is a cross-sectional diagram of a compact lens assembly without eye tracking, in accordance with some examples of the present disclosure;

FIG. 2 is a block diagram illustrating an architecture of an image capture and processing device;

FIG. 3 is a block diagram illustrating an architecture of an example extended reality (XR) system, in accordance with some examples of the present disclosure;

FIGS. 4A and 4B are cross-sectional diagrams of a compact lens assembly including an eye tracking system, in accordance with some examples of the present disclosure;

FIGS. 5A and 5B are diagrams illustrating example sensor data captured by an image sensor included in an eye tracking system, in accordance with some examples of the present disclosure;

FIGS. 6A through 6C are diagrams illustrating an example head mounted display including eye tracking systems for each eye with perpendicular orientations, in accordance with some examples of the present disclosure;

FIG. 7 is a diagram illustrating an eye tracking system utilizing two eye tracking systems with perpendicular orientations for a single eye, in accordance with some examples of the present disclosure;

FIG. 8A is a perspective diagram illustrating a head-mounted display (HMD) that performs feature tracking and/or visual simultaneous localization and mapping (VSLAM), in accordance with some examples;

FIG. 8B is a perspective diagram illustrating the head-mounted display (HMD) of FIG. 8A being worn by a user, in accordance with some examples;

FIG. 9A is a perspective diagram illustrating a front surface of a mobile handset that performs feature tracking, eye tracking, and/or visual simultaneous localization and mapping (VSLAM) using one or more front-facing cameras, in accordance with some examples;

FIG. 9B is a perspective diagram illustrating a rear surface of a mobile handset that performs feature tracking, eye tracking and/or visual simultaneous localization and mapping (VSLAM) using one or more rear-facing cameras, in accordance with some examples;

FIG. 10 is a flow diagram illustrating an example of a process for processing one or more frames, in accordance with some examples;

FIG. 11 is a diagram illustrating an example of a computing system for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the application as set forth in the appended claims.

A camera is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor or ISP) for processing the one or more image frames captured by the image sensor.

Extended reality (XR) systems or devices can provide virtual content to a user and/or can combine real-world or physical environments and virtual environments (made up of virtual content) to provide users with XR experiences. The real-world environment can include real-world objects (also referred to as physical objects), such as people, vehicles, buildings, tables, chairs, and/or other real-world or physical objects. XR systems or devices can facilitate interaction with different types of XR environments (e.g., a user can use an XR system or device to interact with an XR environment). XR systems can include virtual reality (VR) systems facilitating interactions with VR environments, augmented reality (AR) systems facilitating interactions with AR environments, mixed reality (MR) systems facilitating interactions with MR environments, and/or other XR systems. Examples of XR systems or devices include head-mounted displays (HMDs), smart glasses, among others. In some cases, an XR system can track parts of the user (e.g., a hand and/or fingertips of a user) to allow the user to interact with items of virtual content.

In some cases, an XR system can include an optical “see-through” or “pass-through” display (e.g., see-through or pass-through AR HMD or AR glasses), allowing the XR system to display XR content (e.g., AR content) directly onto a real-world view without displaying video content. For example, a user may view physical objects through a display (e.g., glasses or lenses), and the AR system can display AR content onto the display to provide the user with an enhanced visual perception of one or more real-world objects. In one example, a display of an optical see-through AR system can include a lens or glass in front of each eye (or a single lens or glass over both eyes). The see-through display can allow the user to see a real-world or physical object directly, and can display (e.g., projected or otherwise displayed) an enhanced image of that object or additional AR content to augment the user's visual perception of the real world.

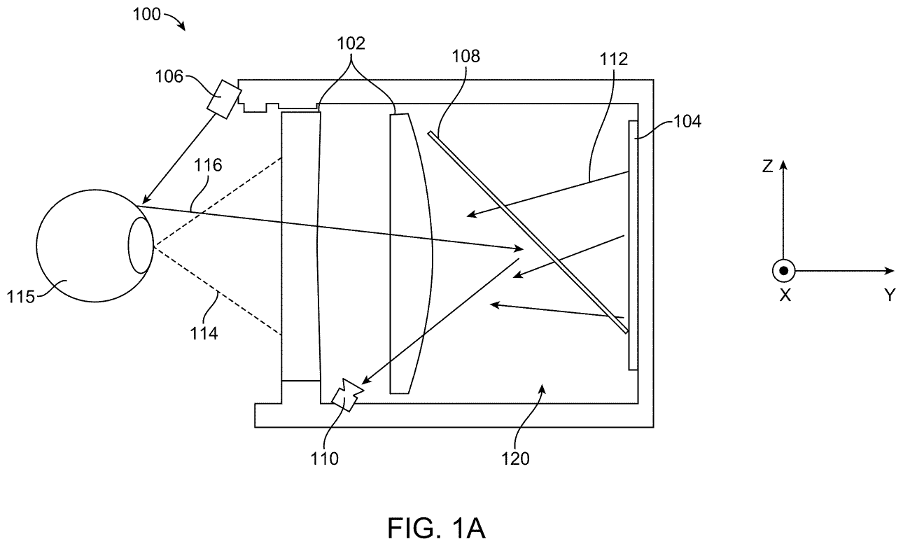

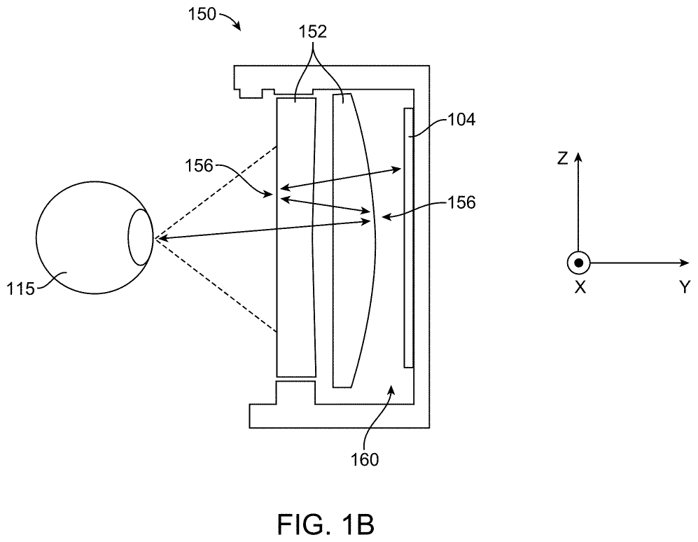

An XR system can include one or more user-facing sensors that face the user, such as user-facing image sensors that face the user. For instance, the user-facing sensors can face the user's face, eyes, one or more other portions of the user's body, and/or a combination thereof. FIG. 1A is a diagram illustrating a simplified cross-sectional view of lens assembly 100 (e.g., of an HMD). In the illustrated example of FIG. 1A, the lens assembly 100 includes a lens system 102, a display 104, an illumination source 106, a light directing component 108, and an image sensor 110.

As illustrated, light from the display 104 can pass through the light directing component 108 and be focused by the lens system 102 on the user's eye 115. In some implementations, the light directing component 108 can be configured to allow visible light from the display 104 to pass through. In the illustrated example of FIG. 1A, the light directing component 108 is positioned within a cavity 120 of the lens assembly 100 between the lens system 102 and the display 104. As illustrated in FIG. 1A, the visible light 112 can be focused at the position of the user's eye 115 as illustrated by the lines 114. In some cases, the light directing component 108 can be configured to reflect other wavelengths of light, such as IR light. In some examples, the light directing component 108 can be implemented using a reflective coating. In some implementations, the light directing component 108 can include a dielectric material that passes visible light and reflects IR light. In some examples, the light directing component can be coated with a transparent conductor. In one illustrative example, an indium-tin-oxide (ITO) material that is transparent to visible light and reflects IR light can be used to coat the light directing component 108. The illumination source 106 can be an IR illumination source (e.g., an IR LED) that illuminates the user's eye 115. When the IR light reaches the user's eye, a scattered and/or reflected portion of the light, such as the example ray 116 can reach the light directing component 108 and reflect toward the image sensor 110.

The image sensor 110 can be an infrared (IR) image sensor that can detect the scattered and/or reflected light from the eye to form one or more images. In some cases, an XR system can obtain image data from the image sensor 110 and track the user's eye position and/or gaze direction based on the obtained data.

FIG. 1B illustrates an example compact lens assembly 150. As illustrated, the compact lens assembly includes a display 104 and a lens system 152. In some implementations, a compact lens assembly can reduce the overall bulk and/or thickness of the compact lens assembly 150 when compared to the lens assembly 100 of FIG. 1A. In some cases, the lens system 152 can provide similar optical characteristics to the lens system 102 while reducing the thickness of the lens system 152 in the y-axis direction. In one illustrative example, the lens system 152 can utilize internal reflections 156 within and/or between individual lens elements in the lens system 152 to achieve the desired optical characteristics. In some implementations, the individual lens components of the lens system 152 can be cemented together (e.g., by a transparent adhesive, epoxy, or the like). In some cases, a compact lens assembly such as the illustrated lens system 152 can be referred to as a pancake lens. In some cases, as a result of reducing the thickness of the lens system 152 and compact lens assembly 150, the cavity 160 remaining within he lens assembly may lack sufficient space to include a light directing component 108 as shown in FIG. 1A. As a result, the compact lens assembly 150 is shown without an eye tracking system.

The illustrations of FIGS. 1A and 1B are not to scale and are provided only for the purposes of illustration. In addition, more or fewer components can be included in the lens assembly 100 of FIG. 1A and/or the compact lens assembly 150 of FIG. 1B without departing from the scope of the present disclosure. Systems and techniques have been developed that can be used to include an eye tracking system in compact lens assemblies such as the lens system 152 of FIG. 1B.

Returning to FIG. 1A, in some cases, the position of a user's eyes relative to the lens assembly 100 can vary. For example, each individual user may have different eyes size, face shape, face symmetry, eye separation, facial feature alignment, and/or a combination thereof. In some implementations, an eye tracking system can be configured to perform eye tracking over a specified range of eye positions and/or rotations. In some cases, if the user's eye moves outside of the specific range, the XR system may be unable to perform eye tracking until the eye returns to a position and/or rotation within the specific range. For example, if the user's eye 115 shown in FIG. 1A rotates to look down (e.g., toward the negative z-axis direction), the image of the user's eye 115 may be obstructed by eyelashes and/or by the curvature of the user's eye 115. In some cases, the range of eye tracking may be limited by the desire to keep the lens assembly of an XR system compact.

Systems and techniques are needed for accurate eye tracking over a large range of possible eye movements and/or positions. For example, functionality supported by eye tracking information may need to determine where a user is looking on a display (e.g., display 104 of FIGS. 1A and 1B), whether the user is looking away from the display, or the like. In some cases, the exact position of the eyes of a user of the XR system may be subject to tolerances that can benefit from expansion of the range of eye tracking systems and techniques.

Systems, apparatuses, processes (also referred to as methods), and computer-readable media (collectively referred to as “systems and techniques”) are described herein for eye tracking over a large range of user eye positions and/or rotations. In some cases, the systems and techniques described herein can be applied to compact lens assemblies. In some cases, the systems and techniques can also be used in lens assemblies of any geometry. The systems and techniques described herein may also expand the range of eye tracking with limited or no visual artifacts for images displayed by a display.

In some cases, the systems and techniques described herein can be used to obtain eye tracking data across the complete range of motion (e.g., translation and/or rotation) of a user's eye. In some cases, the systems and techniques described herein can be used to obtain eye tracking data over a wider range of eye position and/or rotation achievable by a single eye tracking system. By utilizing two or more eye trackers with light directing components (e.g., light directing component 108 of FIG. 1A) oriented along different axes (e.g., vertical and horizontal), the overall field of view of eye tracking systems can be extended to include the combined eye tracking field of view of all of the two or more sensors. In some cases, each eye tracking system may have a wider field of view for motion and/or rotation along a first axis (e.g., the axis of orientation of the light directing component) and a narrower field of view along a second axis, perpendicular to the first axis. In some cases, the distance of the displayed image (e.g., a projected virtual image) from a display can be far enough away from a user's eyes that the user's eyes will move together when looking at the display. In some cases, an eye tracker oriented in the first direction can track position and/or rotation of a first eye of a user, and an eye tracker oriented in the second direction can track position and/or rotation of a second eye of a user. In some implementations, the overall range for eye tracking from can be increased using eye tracking on the data from both eye trackers. For example, one eye tracker can be used to track vertical movement and/or rotation of the first eye, and another eye tracker can be used to track horizontal movement and/or rotation of the second eye. Because the eyes move together, as long as one of the eyes is within range of either of the eye trackers, the position of both of the user's eyes can be determined.

While examples are described herein for eye tracking in XR systems, the eye tracking systems and techniques described herein can be used for eye tracking with other types of devices. In addition, while examples are described herein for eye tracking for compact lens assemblies, the systems and techniques described herein can be used with other geometries (e.g., the lens assembly 100 of FIG. 1A).

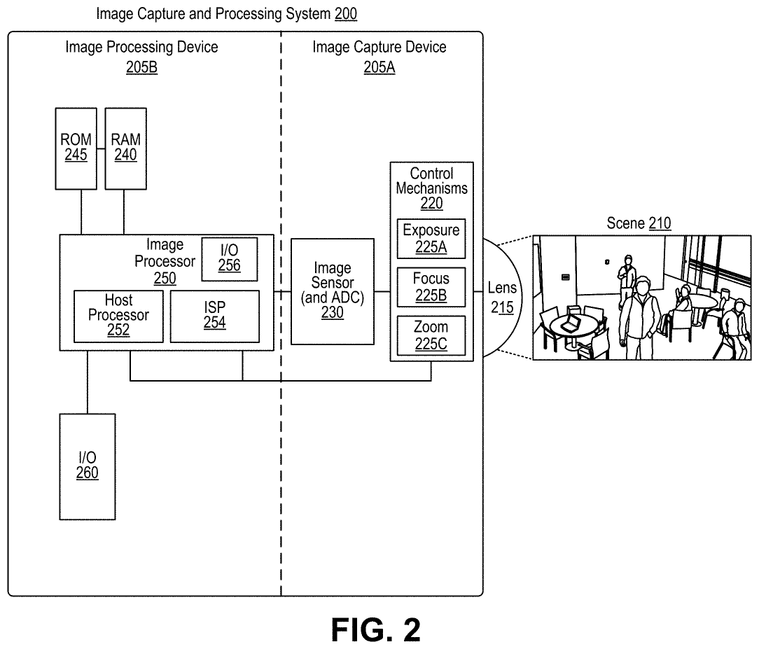

Various aspects of the techniques described herein will be discussed below with respect to the figures. FIG. 2 is a block diagram illustrating an architecture of an image capture and processing system 200. The image capture and processing system 200 includes various components that are used to capture and process images of scenes (e.g., an image of a scene 210). The image capture and processing system 200 can capture standalone images (or photographs) and/or can capture videos that include multiple images (or video frames) in a particular sequence. In some cases, the lens 215 and image sensor 230 can be associated with an optical axis. In one illustrative example, the photosensitive area of the image sensor 230 (e.g., the photodiodes) and the lens 215 can both be centered on the optical axis. A lens 215 of the image capture and processing system 200 faces a scene 210 and receives light from the scene 210. The lens 215 bends incoming light from the scene toward the image sensor 230. The light received by the lens 215 passes through an aperture. In some cases, the aperture (e.g., the aperture size) is controlled by one or more control mechanisms 220 and is received by an image sensor 230. In some cases, the aperture can have a fixed size.

The one or more control mechanisms 220 may control exposure, focus, and/or zoom based on information from the image sensor 230 and/or based on information from the image processor 250. The one or more control mechanisms 220 may include multiple mechanisms and components; for instance, the control mechanisms 220 may include one or more exposure control mechanisms 225A, one or more focus control mechanisms 225B, and/or one or more zoom control mechanisms 225C. The one or more control mechanisms 220 may also include additional control mechanisms besides those that are illustrated, such as control mechanisms controlling analog gain, flash, HDR, depth of field, and/or other image capture properties.

The focus control mechanism 225B of the control mechanisms 220 can obtain a focus setting. In some examples, focus control mechanism 225B store the focus setting in a memory register. Based on the focus setting, the focus control mechanism 225B can adjust the position of the lens 215 relative to the position of the image sensor 230. For example, based on the focus setting, the focus control mechanism 225B can move the lens 215 closer to the image sensor 230 or farther from the image sensor 230 by actuating a motor or servo (or other lens mechanism), thereby adjusting focus. In some cases, additional lenses may be included in the image capture and processing system 200, such as one or more microlenses over each photodiode of the image sensor 230, which each bend the light received from the lens 215 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 220, the image sensor 230, and/or the image processor 250. The focus setting may be referred to as an image capture setting and/or an image processing setting. In some cases, the lens 215 can be fixed relative to the image sensor and focus control mechanism 225B can be omitted without departing from the scope of the present disclosure.

The exposure control mechanism 225A of the control mechanisms 220 can obtain an exposure setting. In some cases, the exposure control mechanism 225A stores the exposure setting in a memory register. Based on this exposure setting, the exposure control mechanism 225A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 230 (e.g., ISO speed or film speed), analog gain applied by the image sensor 230, or any combination thereof. The exposure setting may be referred to as an image capture setting and/or an image processing setting.

The zoom control mechanism 225C of the control mechanisms 220 can obtain a zoom setting. In some examples, the zoom control mechanism 225C stores the zoom setting in a memory register. Based on the zoom setting, the zoom control mechanism 225C can control a focal length of an assembly of lens elements (lens assembly) that includes the lens 215 and one or more additional lenses. For example, the zoom control mechanism 225C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 215 in some cases) that receives the light from the scene 210 first, with the light then passing through an afocal zoom system between the focusing lens (e.g., lens 215) and the image sensor 230 before the light reaches the image sensor 230. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 225C moves one or more of the lenses in the afocal zoom system, such as the negative lens and one or both of the positive lenses. In some cases, zoom control mechanism 225C can control the zoom by capturing an image from an image sensor of a plurality of image sensors (e.g., including image sensor 230) with a zoom corresponding to the zoom setting. For example, image capture and processing system 200 can include a wide angle image sensor with a relatively low zoom and a telephoto image sensor with a greater zoom. In some cases, based on the selected zoom setting, the zoom control mechanism 225C can capture images from a corresponding sensor.

The image sensor 230 includes one or more arrays of photodiodes or other photosensitive elements. Each photodiode measures an amount of light that eventually corresponds to a particular pixel in the image produced by the image sensor 230. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 2, other types of color filters may use yellow, magenta, and/or cyan (also referred to as “emerald”) color filters instead of or in addition to red, blue, and/or green color filters. In some cases, some photodiodes may be configured to measure IR light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 230) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 230 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 230 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 220 may be included instead or additionally in the image sensor 230. The image sensor 230 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

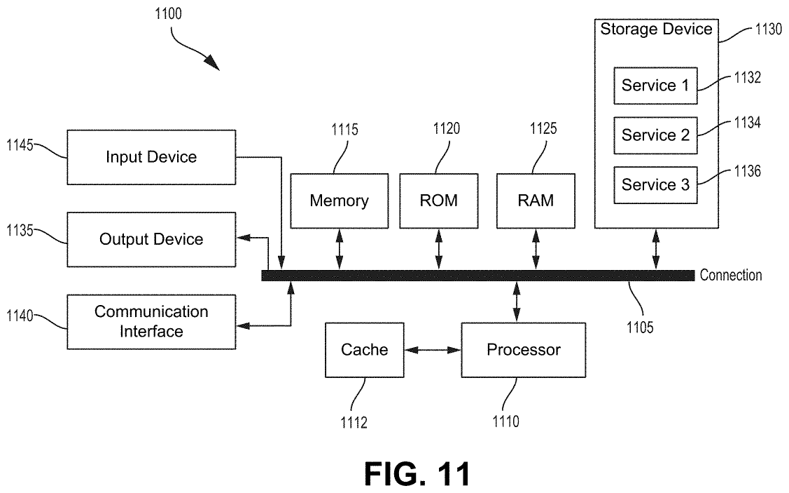

The image processor 250 may include one or more processors, such as one or more image signal processors (ISPs) (including ISP 254), one or more host processors (including host processor 252), and/or one or more of any other type of processor 1110 discussed with respect to the computing system 1100 of FIG. 11. The host processor 252 can be a digital signal processor (DSP) and/or other type of processor. In some implementations, the image processor 250 is a single integrated circuit or chip (e.g., referred to as a system-on-chip or SoC) that includes the host processor 252 and the ISP 254. In some cases, the chip can also include one or more input/output ports (e.g., input/output (I/O) ports 256), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 256 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 252 can communicate with the image sensor 230 using an I2C port, and the ISP 254 can communicate with the image sensor 230 using an MIPI port.

The image processor 250 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 250 may store image frames and/or processed images in random access memory (RAM) 240/1125, read-only memory (ROM) 245/1120, a cache, a memory unit, another storage device, or some combination thereof.

Various input/output (I/O) devices 260 may be connected to the image processor 250. The I/O devices 260 can include a display screen, a keyboard, a keypad, a touchscreen, a trackpad, a touch-sensitive surface, a printer, any other output devices 1135, any other input devices 1145, or some combination thereof. In some cases, a caption may be input into the image processing device 205B through a physical keyboard or keypad of the I/O devices 260, or through a virtual keyboard or keypad of a touchscreen of the I/O devices 260. The I/O 260 may include one or more ports, jacks, or other connectors that enable a wired connection between the image capture and processing system 200 and one or more peripheral devices, over which the image capture and processing system 200 may receive data from the one or more peripheral device and/or transmit data to the one or more peripheral devices. The I/O 260 may include one or more wireless transceivers that enable a wireless connection between the image capture and processing system 200 and one or more peripheral devices, over which the image capture and processing system 200 may receive data from the one or more peripheral device and/or transmit data to the one or more peripheral devices. The peripheral devices may include any of the previously-discussed types of I/O devices 260 and may themselves be considered I/O devices 260 once they are coupled to the ports, jacks, wireless transceivers, or other wired and/or wireless connectors.

In some cases, the image capture and processing system 200 may be a single device. In some cases, the image capture and processing system 200 may be two or more separate devices, including an image capture device 205A (e.g., a camera) and an image processing device 205B (e.g., a computing device coupled to the camera). In some implementations, the image capture device 205A and the image processing device 205B may be coupled together, for example via one or more wires, cables, or other electrical connectors, and/or wirelessly via one or more wireless transceivers. In some implementations, the image capture device 205A and the image processing device 205B may be disconnected from one another.

As shown in FIG. 2, a vertical dashed line divides the image capture and processing system 200 of FIG. 2 into two portions that represent the image capture device 205A and the image processing device 205B, respectively. The image capture device 205A includes the lens 215, control mechanisms 220, and the image sensor 230. The image processing device 205B includes the image processor 250 (including the ISP 254 and the host processor 252), the RAM 240, the ROM 245, and the I/O 260. In some cases, certain components illustrated in the image capture device 205A, such as the ISP 254 and/or the host processor 252, may be included in the image capture device 205A.

The image capture and processing system 200 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 200 can include one or more wireless transceivers for wireless communications, such as cellular network communications, 802.11 wi-fi communications, wireless local area network (WLAN) communications, or some combination thereof. In some implementations, the image capture device 205A and the image processing device 205B can be different devices. For instance, the image capture device 205A can include a camera device and the image processing device 205B can include a computing device, such as a mobile handset, a desktop computer, or other computing device.

While the image capture and processing system 200 is shown to include certain components, one of ordinary skill will appreciate that the image capture and processing system 200 can include more components than those shown in FIG. 2. The components of the image capture and processing system 200 can include software, hardware, or one or more combinations of software and hardware. For example, in some implementations, the components of the image capture and processing system 200 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 200.

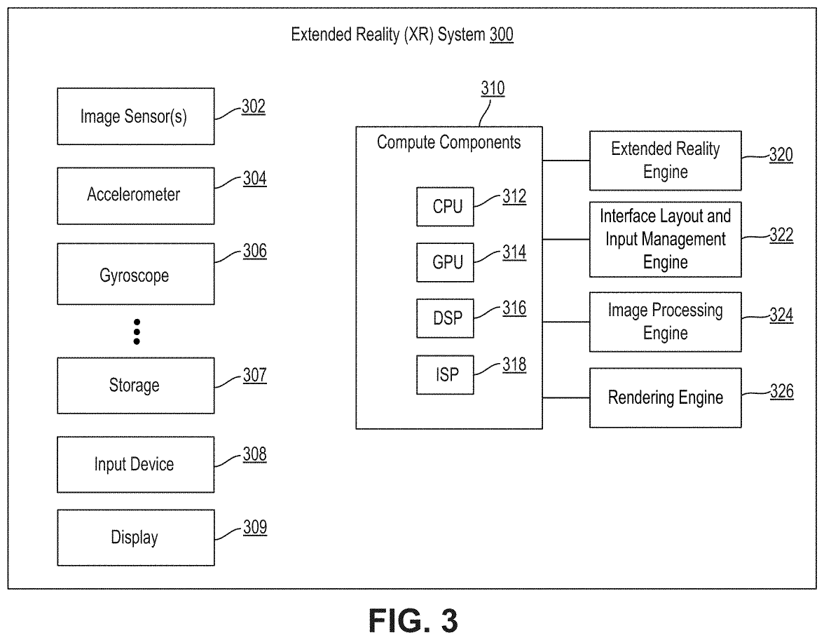

In some examples, the extended reality (XR) system 300 of FIG. 3 can include the image capture and processing system 200, the image capture device 205A, the image processing device 205B, or a combination thereof.

FIG. 3 is a diagram illustrating an architecture of an example extended reality (XR) system 300, in accordance with some aspects of the disclosure. The XR system 300 can run (or execute) XR applications and implement XR operations. In some examples, the XR system 300 can perform tracking and localization, mapping of an environment in the physical world (e.g., a scene), and/or positioning and rendering of virtual content on a display 309 (e.g., a screen, visible plane/region, and/or other display) as part of an XR experience. For example, the XR system 300 can generate a map (e.g., a three-dimensional (3D) map) of an environment in the physical world, track a pose (e.g., location and position) of the XR system 300 relative to the environment (e.g., relative to the 3D map of the environment), position and/or anchor virtual content in a specific location(s) on the map of the environment, and render the virtual content on the display 309 such that the virtual content appears to be at a location in the environment corresponding to the specific location on the map of the scene where the virtual content is positioned and/or anchored. The display 309 can include a glass, a screen, a lens, a projector, and/or other display mechanism that allows a user to see the real-world environment and also allows XR content to be overlaid, overlapped, blended with, or otherwise displayed thereon.

In this illustrative example, the XR system 300 includes one or more image sensors 302, an accelerometer 304, a gyroscope 306, storage 307, compute components 310, an XR engine 320, an interface layout and input management engine 322, an image processing engine 324, and a rendering engine 326. It should be noted that the components 302-226 shown in FIG. 3 are non-limiting examples provided for illustrative and explanation purposes, and other examples can include more, less, or different components than those shown in FIG. 3. For example, in some cases, the XR system 300 can include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors. audio sensors, etc.), one or more display devices, one more other processing engines, one or more other hardware components, and/or one or more other software and/or hardware components that are not shown in FIG. 3. While various components of the XR system 300, such as the accelerometer 304, may be referenced in the singular form herein, it should be understood that the XR system 300 may include multiple of any component discussed herein (e.g., multiple accelerometers 304).

The XR system 300 includes or is in communication with (wired or wirelessly) an input device 308. The input device 308 can include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device 1145 discussed herein, or any combination thereof. In some cases, one or more image sensors 302 can capture images that can be processed for interpreting gesture commands.

In some implementations, the one or more image sensors 302, the accelerometer 304, the gyroscope 306, storage 307, compute components 310, XR engine 320, interface layout and input management engine 322, image processing engine 324, and rendering engine 326 can be part of the same computing device. For example, in some cases, the one or more image sensors 302, the accelerometer 304, the gyroscope 306, storage 307, compute components 310, XR engine 320, interface layout and input management engine 322, image processing engine 324, and rendering engine 326 can be integrated into an HMD, extended reality glasses, smartphone, laptop, tablet computer, gaming system, and/or any other computing device. However, in some implementations, the one or more image sensors 302, the accelerometer 304, the gyroscope 306, storage 307, compute components 310, XR engine 320, interface layout and input management engine 322, image processing engine 324, and rendering engine 326 can be part of two or more separate computing devices. For example, in some cases, some of the components 302-226 can be part of, or implemented by, one computing device and the remaining components can be part of, or implemented by, one or more other computing devices.

The storage 307 can be any storage device(s) for storing data. Moreover, the storage 307 can store data from any of the components of the XR system 300. For example, the storage 307 can store data from the one or more image sensors 302 (e.g., image or video data), data from the accelerometer 304 (e.g., measurements), data from the gyroscope 306 (e.g., measurements), data from the compute components 310 (e.g., processing parameters, preferences, virtual content, rendering content, scene maps, tracking and localization data, object detection data, privacy data, XR application data, face recognition data, occlusion data, etc.), data from the XR engine 320, data from the interface layout and input management engine 322, data from the image processing engine 324, and/or data from the rendering engine 326 (e.g., output frames). In some examples, the storage 307 can include a buffer for storing frames for processing by the compute components 310.

The one or more compute components 310 can include a central processing unit (CPU) 312, a graphics processing unit (GPU) 314, a digital signal processor (DSP) 316, an image signal processor (ISP) 318, and/or other processor (e.g., a neural processing unit (NPU) implementing one or more trained neural networks). The compute components 310 can perform various operations such as image enhancement, computer vision, graphics rendering, extended reality operations (e.g., tracking, localization, pose estimation, mapping, content anchoring, content rendering, etc.), image and/or video processing, sensor processing, recognition (e.g., text recognition, facial recognition, object recognition, feature recognition, tracking or pattern recognition, scene recognition, occlusion detection, etc.), trained machine learning operations, filtering, and/or any of the various operations described herein. In some examples, the compute components 310 can implement (e.g., control, operate, etc.) the XR engine 320, the interface layout and input management engine 322, the image processing engine 324, and the rendering engine 326. In other examples, the compute components 310 can also implement one or more other processing engines.

The one or more image sensors 302 can include any image and/or video sensors or capturing devices. The one or more image sensors 302 can include one or more user-facing image sensors. In some cases, user-facing images sensors included in the one or more image sensors 302. In some examples, user-facing image sensors can be used for face tracking, eye tracking, body tracking, and/or any combination thereof. The one or more image sensors 302 can include one or more environment facing sensors. In some cases, the environment facing sensors can face in a similar direction to the gaze direction of a user. In some examples, the one or more image sensors 302 can be part of a multiple-camera assembly, such as a dual-camera assembly. The one or more image sensors 302 can capture image and/or video content (e.g., raw image and/or video data), which can then be processed by the compute components 310, the XR engine 320, the interface layout and input management engine 322, the image processing engine 324, and/or the rendering engine 326 as described herein. In some examples, the image sensors 302 may include an image capture and processing system 200, an image capture device 205A, an image processing device 205B, or a combination thereof.

In some examples, one or more image sensors 302 can capture image data and can generate images (also referred to as frames) based on the image data and/or can provide the image data or frames to the XR engine 320, the interface layout and input management engine 322, the image processing engine 324, and/or the rendering engine 326 for processing. An image or frame can include a video frame of a video sequence or a still image. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, one or more image sensors 302 (and/or other camera of the XR system 300) can be configured to also capture depth information. For example, in some implementations, one or more image sensors 302 (and/or other camera) can include an RGB-depth (RGB-D) camera. In some cases, the XR system 300 can include one or more depth sensors (not shown) that are separate from one or more image sensors 302 (and/or other camera) and that can capture depth information. For instance, such a depth sensor can obtain depth information independently from one or more image sensors 302. In some examples, a depth sensor can be physically installed in the same general location as one or more image sensors 302 but may operate at a different frequency or frame rate from one or more image sensors 302. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

The XR system 300 can also include other sensors in its one or more sensors. The one or more sensors can include one or more accelerometers (e.g., accelerometer 304), one or more gyroscopes (e.g., gyroscope 306), and/or other sensors. The one or more sensors can provide velocity, orientation, and/or other position-related information to the compute components 310. For example, the accelerometer 304 can detect acceleration by the XR system 300 and can generate acceleration measurements based on the detected acceleration. In some cases, the accelerometer 304 can provide one or more translational vectors (e.g., up/down, left/right, forward/back) that can be used for determining a position or pose of the XR system 300. The gyroscope 306 can detect and measure the orientation and angular velocity of the XR system 300. For example, the gyroscope 306 can be used to measure the pitch, roll, and yaw of the XR system 300. In some cases, the gyroscope 306 can provide one or more rotational vectors (e.g., pitch, yaw, roll). In some examples, the one or more image sensors 302 and/or the XR engine 320 can use measurements obtained by the accelerometer 304 (e.g., one or more translational vectors) and/or the gyroscope 306 (e.g., one or more rotational vectors) to calculate the pose of the XR system 300. The XR system 300 can include a gaze and/or eye tracking sensor. In some examples, the gaze and/or eye tracking sensor can obtain images of one or both of a user's eyes from user-facing image sensors of the one or more image sensors 302. As previously noted, in other examples, the XR system 300 can also include other sensors, such as an inertial measurement unit (IMU), a magnetometer a machine vision sensor, a smart scene sensor, a speech recognition sensor, an impact sensor, a shock sensor, a position sensor, a tilt sensor, etc.

As noted above, in some cases, the one or more sensors can include at least one IMU. An IMU is an electronic device that measures the specific force, angular rate, and/or the orientation of the XR system 300, using a combination of one or more accelerometers, one or more gyroscopes, and/or one or more magnetometers. In some examples, the one or more sensors can output measured information associated with the capture of an image captured by one or more image sensors 302 (and/or other camera of the XR system 300) and/or depth information obtained using one or more depth sensors of the XR system 300.

The output of one or more sensors (e.g., the accelerometer 304, the gyroscope 306, one or more IMUs, and/or other sensors) can be used by the XR engine 320 to determine a pose of the XR system 300 (also referred to as the head pose) and/or the pose of one or more image sensors 302 (or other camera of the XR system 300). In some cases, the pose of the XR system 300 and the pose of one or more image sensors 302 (or other camera) can be the same. The pose of image sensor 302 refers to the position and orientation of one or more image sensors 302 relative to a frame of reference (e.g., with respect to an object). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees Of Freedom (3DoF), which refers to the three angular components (e.g. roll, pitch, and yaw).

In some cases, a device tracker (not shown) can use the measurements from the one or more sensors and image data from one or more image sensors 302 to track a pose (e.g., a 6DoF pose) of the XR system 300. For example, the device tracker can fuse visual data (e.g., using a visual tracking solution) from the image data with inertial data from the measurements to determine a position and motion of the XR system 300 relative to the physical world (e.g., the scene) and a map of the physical world. As described below, in some examples, when tracking the pose of the XR system 300, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of the XR system 300 within the scene and the 3D map of the scene, etc. The 3D map can provide a digital representation of a scene in the real/physical world. In some examples, the 3D map can anchor location-based objects and/or content to real-world coordinates and/or objects. The XR system 300 can use a mapped scene (e.g., a scene in the physical world represented by, and/or associated with, a 3D map) to merge the physical and virtual worlds and/or merge virtual content or objects with the physical environment.

In some aspects, the pose of image sensor 302 and/or the XR system 300 as a whole can be determined and/or tracked by the compute components 310 using a visual tracking solution based on images captured by one or more image sensors 302 (and/or other camera of the XR system 300). For instance, in some examples, the compute components 310 can perform tracking using computer vision-based tracking, model-based tracking, and/or simultaneous localization and mapping (SLAM) techniques. For instance, the compute components 310 can perform SLAM or can be in communication (wired or wireless) with a SLAM system (not shown). SLAM refers to a class of techniques where a map of an environment (e.g., a map of an environment being modeled by XR system 300) is created while simultaneously tracking the pose of a camera (e.g., image sensor 302) and/or the XR system 300 relative to that map. The map can be referred to as a SLAM map and can be three-dimensional (3D). The SLAM techniques can be performed using color or grayscale image data captured by one or more image sensors 302 (and/or other camera of the XR system 300), and can be used to generate estimates of 6DoF pose measurements of one or more image sensors 302 and/or the XR system 300. Such a SLAM technique configured to perform 6DoF tracking can be referred to as 6DoF SLAM. In some cases, the output of the one or more sensors (e.g., the accelerometer 304, the gyroscope 306, one or more IMUs, and/or other sensors) can be used to estimate, correct, and/or otherwise adjust the estimated pose.

In some cases, the 6DoF SLAM (e.g., 6DoF tracking) can associate features observed from certain input images from one or more image sensors 302 (and/or other camera) to the SLAM map. For example, 6DoF SLAM can use feature point associations from an input image to determine the pose (position and orientation) of one or more image sensors 302 and/or XR system 300 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of one or more image sensors 302 and/or the XR system 300 can be determined by projecting features from the 3D SLAM map into an image or video frame and updating the camera pose from verified 2D-3D correspondences.

In one illustrative example, the compute components 310 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

In some cases, the XR system 300 can also track the hand and/or fingers of the user to allow the user to interact with and/or control virtual content in a virtual environment. For example, the XR system 300 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

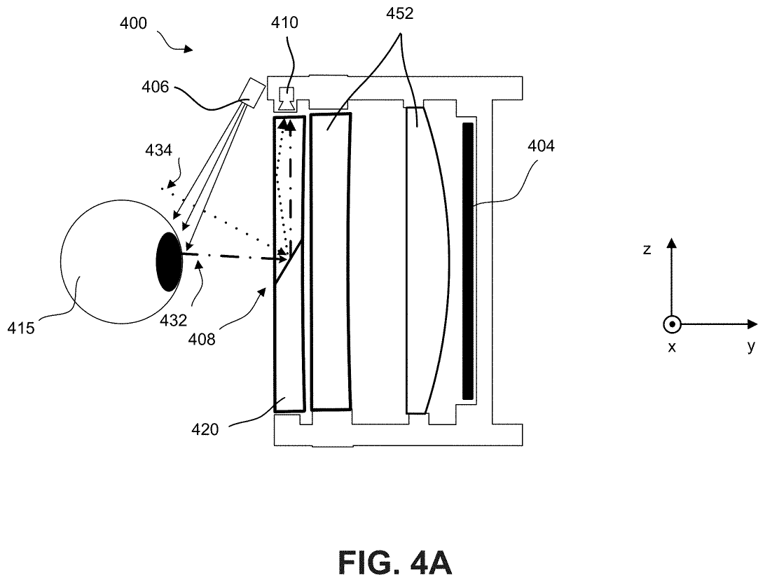

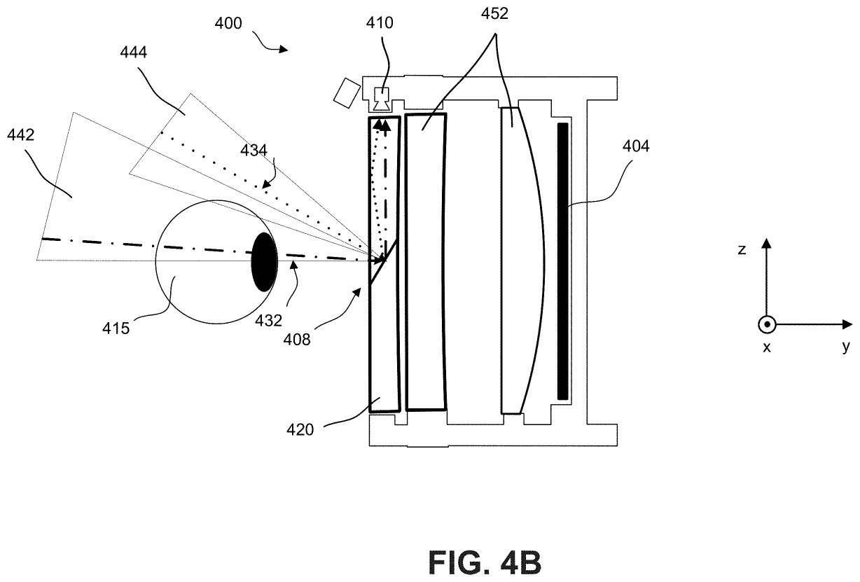

FIG. 4A is a cross-sectional diagram of a compact lens assembly 400 including an eye tracking system. As illustrated, the compact lens assembly 400 includes a display 404, an illumination source 406, a light directing component 408, an image sensor 410, a light guiding component 420, and a compact lens system 452. The display 404, illumination source 406, image sensor 410, and compact lens system 452 can be similar to and perform similar functions to similarly numbered components (e.g., 104, 106, 110, 152) in the compact lens assembly 150 of FIG. 1B. In some examples, the image sensor 410 can correspond to a user-facing image sensor of the one or more image sensors 302 of FIG. 3.

As illustrated in FIG. 4A, the light guiding component 420 can be disposed between the user's eye 415 and the compact lens system 452. In one illustrative example, the light guiding component 420 can include a polycarbonate sheet. In some cases, the light guiding component 420 can be configured to provide total internal reflection of light (including IR light) over a range of angles of incidence at boundaries between the inside of the light guiding component 420 and the outside of the light guiding component 420. In one illustrative example, the light guiding component 420 can be surrounded by air on either side. In some embodiments, the light directing component 408 can be used to redirect the angle of light entering the light guiding component 420 (e.g., light reflected from the user's eye 415) into the light guiding component 420. In some cases, the light directing component 408 can include a mirror embedded within the light guiding component 420. In one illustrative example, a hot mirror can be embedded in the light guiding component 420 to redirect IR into the light guiding component 420. In another illustrative example, a transparent metallic coating (e.g., ITO) can be applied to a substrate to reflect IR light while allowing visible light to pass through.

In some implementations, an image sensor 410 can be positioned at one end (e.g., the upper end in the z-axis direction as illustrated) of the light guiding component 420 to capture light (e.g., IR light) reflected by the light directing component 408 that reaches the corresponding end of the light guide. In some cases, for angles of incidence with the boundary between the light guiding component 420 and the material (e.g., air) on the outside of the 420 at the edge, the light will not be reflected and can reach the image sensor 410. FIG. 4A illustrates two example paths 432, 434 of light reaching the image sensor 410. The first light path 432 (illustrated with a dashed-and-dotted line) can be referred to as a direct path, where the light reflected from the user's eye 415 reflects from the 408 and reaches the image sensor 410 without undergoing any internal reflections within the light guiding component 420. The second light path 434 (illustrated with a dotted line) can be referred to as an indirect path, where light reflected from the user's eye 415 (e.g., when the user's eye is rotated and/or translated in the positive z-axis direction relative to the illustration of FIG. 4A), undergoes at least one internal reflection within the light directing component 408. In the illustrated example, the two example paths 434 undergoes only a single internal reflection within the light guiding component 420, but other angles of incidence may result in light reflected by the light directing component 408 reaching the image sensor 410 after two or more internal reflections. In some cases, the direct path 432, the indirect path 434, and any additional indirect paths (not shown) may produce an image of the user's eye at slightly different locations (e.g., different pixels) of the image sensor 410.

Referring to FIG. 4B, the direct path 432 is only one example ray that can follow a direct path to the image sensor 410. The angular range 442 that includes the direct path 432 as well as any other incoming ray path that will also follow a direct path to image sensor 410 is illustrated as a triangle in FIG. 4B. Similarly, angular range 444 that includes the indirect path 432 as well as any incoming ray paths that will also follow the indirect path 432 (e.g., with one internal reflection) is also illustrated as a triangle. As shown in the example of FIG. 4B, the angular ranges 442, 444, for different paths can have overlapping regions. As can also be seen from FIG. 4B, the closer the user's eye 415 is to the light directing component 408 and light guiding component 420, the smaller corresponding vertical displacement can be detected within each of the angular ranges 442, 444. In addition, the dimensions of the light directing component 408, the angle of the light directing component 408, the thickness (e.g., in the y-axis direction) of the light guiding component 420, and/or any combination thereof can affect the vertical (e.g., in the z-axis direction) range of motion and/or rotation of the user's eye 415 that can be detected by the image sensor 410. In some cases, a desire to keep the overall thickness of the light guiding component 420 low can limit the vertical range of motion that can be detected by the image sensor 410 with light reflected by the light directing component 408.

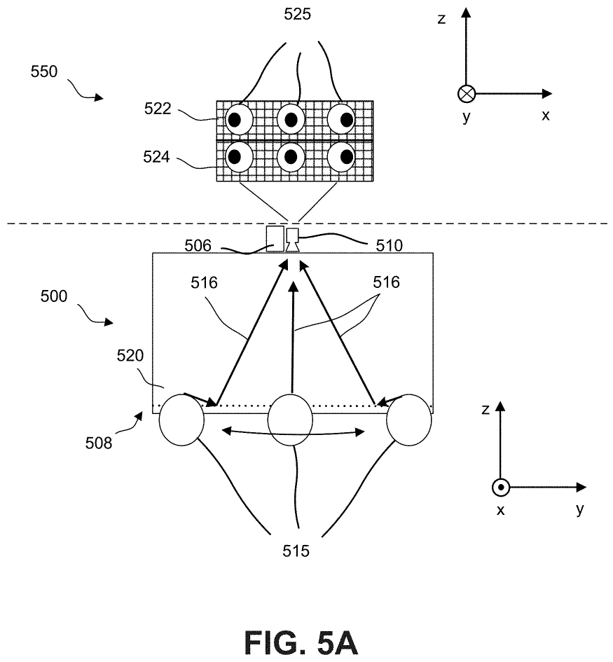

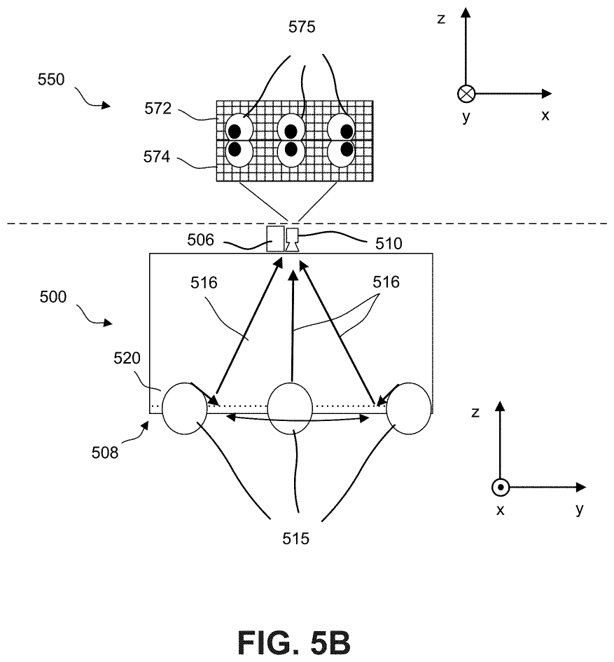

FIGS. 5A and 5B illustrate example sensor data captured by an image sensor included in an eye tracking system 500. In the illustrated example, components of a device including the eye tracking system 500 are omitted for the purposes of illustration. The illustrated positions of the images 525 in FIGS. 5A and 5B are for illustration purposes only, and other configurations can be used without departing from the scope of the present disclosure. For example, the image sensor 510 can be configured to only produce images 522 associated with the direct path, images 524 associated with the indirect path, images associated with other indirect paths (not shown) partial images associated with one or more direct or indirect paths (not shown), and/or any combination thereof.

As illustrated in FIG. 5A, a user's eye 515 is shown in three different positions and/or rotations relative to a light guiding component 520 (e.g., light guiding component 420 of FIGS. 4A and 4B) that includes a light directing component 508 (e.g., light directing component 408 of FIGS. 4A and 4B). The location of the light directing component 508 within the light guiding component 520 is illustrated by a dotted line. The eye tracking system 500 can also include an illumination source 506, which can be similar to and perform similar functions to illumination source 406 of FIGS. 4A and 4B. As illustrated, IR light from illumination source 506 can be scattered and/or reflected by the user's eye 515 at different positions, and can in turn be reflected by the light directing component 508, guided through the light guiding component 520 through direct paths (e.g., direct path 432 of FIGS. 4A and 4B) and/or indirect paths by internal reflection within the light guiding component 520 (e.g., indirect path 434 of FIGS. 4A and 4B) as indicated by the paths 516. In some cases, light from the eye that reaches the image sensor 510 can be focused on an array of photodiodes 550 (also referred to herein as a pixel array). In the illustrated example, images 525 of the eye at different pixel positions of the pixel array. As illustrated, each lateral position of the eye (e.g., along the x-axis) has two corresponding images 525 on the pixel array 550. In one illustrative example, the first set of images 522 can correspond to light arriving at the image sensor 510 through a direct path (e.g., direct path 432 of FIGS. 4A and 4B) and the second set of images 524 can correspond to light arriving at the image sensor 510 through an indirect path (e.g., two example paths 434 of FIGS. 4A and 4B).

As illustrated, the light directing component 508 extends across the full width (e.g., in the y-axis direction) of the light guiding component 520, and as a result complete images of the user's eye 515 are provided for all three example positions of a user's eye 515 as shown in FIG. 5A. In one illustrative example, the eye tracking system 500 can be included in a single lens assembly (e.g., compact lens assembly 150 of FIG. 1B, compact lens assembly 400 of FIGS. 4A and 4B) of an HMD.

FIG. 5B illustrates the eye tracking system 500 and corresponding images 575 produced by the image sensor 510 when the user's eye is shifted vertically (e.g., in the z-axis direction) relative to FIG. 5A. As illustrated in images 572, 574 the whites of the user's eye 515 are not fully captured. In some cases (not shown), one of the images 572, 574 may fully include the eye while the other of the images 572, 574 may only include a partial portion of the user's eye 515. In some cases, both images 572 and 574 may include partial images of different portions of the user's eye 515. In some cases, the portion of the user's eye 515 captured in each of the images 572, 574 can depend on the angular ranges (e.g., angular ranges 442, 444 of FIG. 4B). As should be understood from the illustrations of FIGS. 5A and 5B, if the user's eye 515 moves vertically (e.g., in the positive z-axis direction) beyond the position shown in FIG. 5B, the iris, pupil, and eventually the entire user's eye 515 may no longer be detected by the image sensor 510. As noted above with respect to FIG. 4B, the angular range of the image sensor can be determined by the geometry of the eye tracking system 500 and relative positioning of the user's eye 515. In some cases, extending the angular range (and corresponding vertical range) of the configuration shown in FIGS. 5A and 5B can require increasing the size of the light guiding component 520, visual artifacts, and/or any combination thereof.

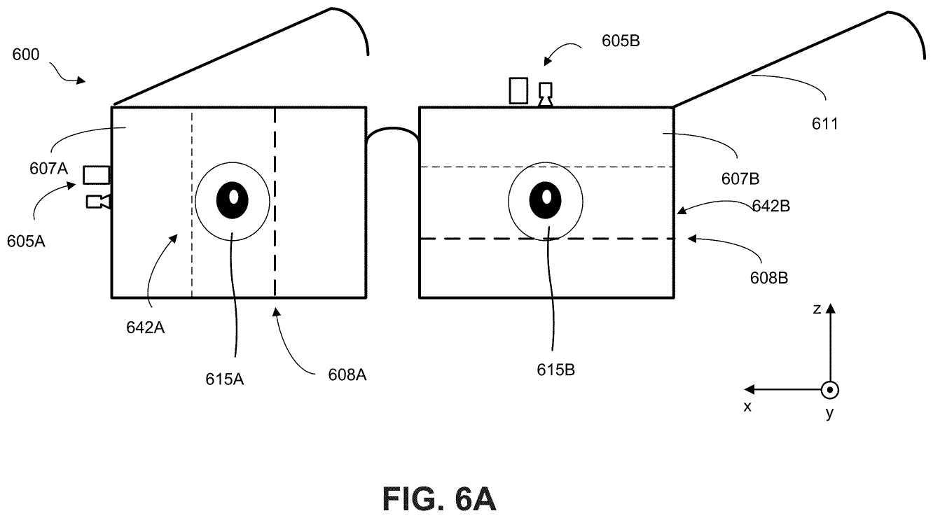

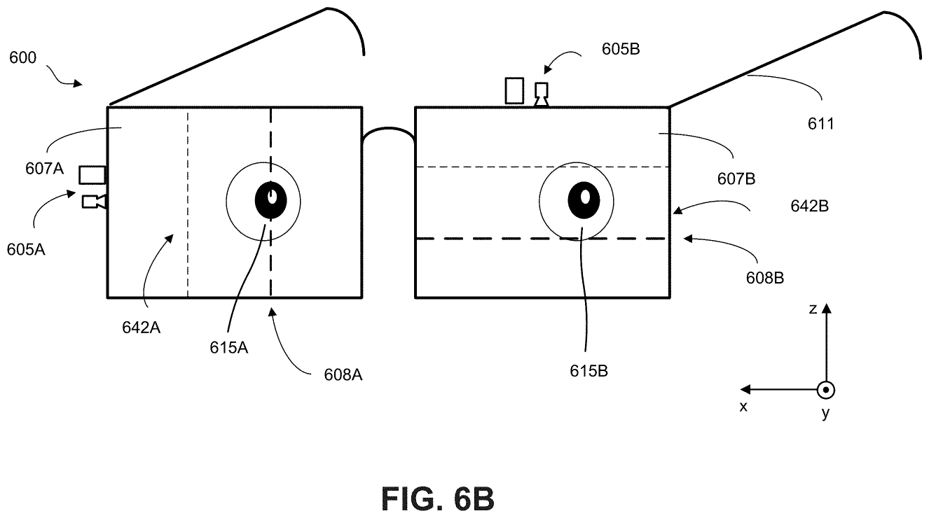

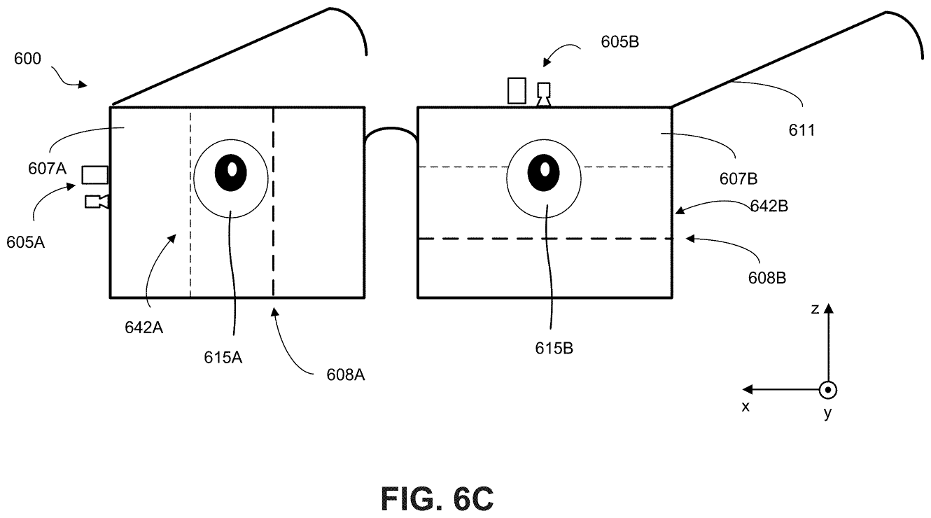

FIGS. 6A through 6C illustrate an example eye tracking system configuration 600 for extending the eye tracking range while utilizing eye tracking components that are compatible with a compact lens assembly. In the illustrated example, the eye tracking system configuration 600 is included in an HMD 611 of an XR system. In some implementations, a display (not shown) of the HMD 611 can be configured to project a virtual image at a specified distance from the user's eyes 615A, 615B. For example, the virtual image can be projected at a distance of at least ten centimeter (cm) from the user's eyes, one meter (m) from the user's eyes, or at least 3 m from the user's eyes, at least 10 m from the user's eyes.

In the illustrated example, the HMD 611 is configured as a pair of glasses with separate lenses 607A, 607B for each of the user's eyes 615A, 615B. As illustrated, each lens 607A, 607B includes a corresponding eye tracking system 605A, 605B. As illustrated, the eye tracking system 605A includes a light directing component 608A oriented vertically (e.g., in the z-axis direction). In contrast, the eye tracking system 605B includes a light directing component 608B oriented horizontally (e.g., in the x-axis direction), perpendicular to the light directing component 608A. FIGS. 6A through 6C also show an effective imaging range 642A for eye tracking system 605A and effective imaging range 642B for eye tracking system 605B. In some cases, the effective imaging ranges 642A, 642B can correspond to an aggregation of the angular ranges (e.g., angular ranges 442, 444 of FIG. 4B) for multiple paths of IR light (e.g., direct path 432 of FIGS. 4A and 4B, indirect path 434 of FIGS. 4A and 4B, other indirect paths, and/or any combination thereof) corresponding to the distance between the user's eyes 615A, 615B, and the eye tracking systems 605A, 605B. As illustrated, the effective imaging range for each of the eye tracking systems 605A, 605B can span approximately the full dimension spanned by the corresponding light directing component 608A, 608B while having a more limited range in the direction perpendicular to the corresponding light directing component 608A, 608B.

As shown in FIG. 6A, when the user's eyes are approximately centered within both of the effective imaging ranges 642A, 642B, images of both eyes (or a portion of the eye sufficient to perform eye tracking) can be fully captured by both of the eye tracking systems 605A, 605B. FIG. 6B illustrates the same eye tracking system configuration 600 of FIG. 6A with the user's eyes shifted and rotated toward the negative x-axis direction relative to the positions in FIG. 6A. As illustrated, nearly half of the first eye 615A falls outside of the effective imaging range of the eye tracking system 605A. However, the second eye 615B continues to fall within the effective imaging range 642B of the eye tracking system 605B. Similarly, FIG. 6C illustrates the user's eyes 615A, 615B shifted and rotated upward (e.g., in the positive z-axis direction) and as a result, the user's first eye 615A falls within the effective imaging range 642A of the eye tracking system 605A. In addition, a portion of the user's second eye 615B, including a portion of the iris, falls outside of the effective imaging range 642B of the eye tracking system. As described above, when a virtual image is projected at a sufficiently great distance from the user's eyes 615A, 615B, the user's eyes can be expected to move together. In some cases, the detected position and/or rotation of the user's second eye 615B in FIG. 6B can be used to determine the position and/or rotation of the user's first eye 615A in FIG. 6B. Similarly, the detected position and/or rotation of the user's first eye 615A in FIG. 6C can be used to determine the position and/or rotation of the user's second eye 615B in FIG. 6C.

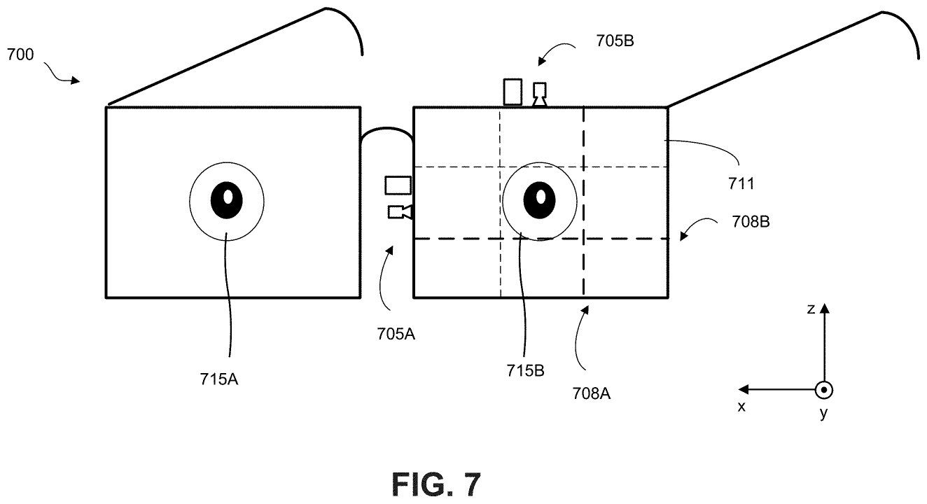

FIG. 7 illustrates another example eye tracking system configuration 700. The eye tracking system configuration 700 is included in an HMD 711 that can be similar to the HMD 611 of FIGS. 6A-6C. As illustrated, the eye tracking system configuration 700 of includes two eye tracking systems 705A and 705B. Each of the individual eye tracking systems 705A, 705B can be similar to the eye tracking system included in compact lens assembly 400 of FIGS. 4A and 4B, eye tracking system 500 of FIGS. 5A and 5B, and/or eye tracking system configuration 600 of FIGS. 6A through 6C. As illustrated, the light directing elements 708A, 708B of the eye tracking systems 705A, 705B can be oriented along different axes. For example, light directing element 708A is illustrated extending along the vertical (e.g., z-axis direction) and light directing element 708B is illustrated extending along the horizontal (e.g., x-axis direction). Although the individual eye tracking systems 705A, 705B of FIG. 7 are illustrated as having perpendicular orientations, the systems and techniques described herein can be used with two eye tracking systems that are not aligned along perpendicular axes without departing from the scope of the present disclosure.

In some implementations, the light directing elements 708A, 708B can be incorporated within a single light guiding component (e.g., light guiding component 520 of FIGS. 5A and 5B). In some implementations the light directing elements 708A, 708B can be incorporated within different light guiding components that can be stacked together as part of a lens assembly (e.g., compact lens assembly 150 of FIG. 1B and/or compact lens assembly 400 of FIGS. 4A and 4B). The images produced by the corresponding image sensors of the eye tracking systems 705A, 705B can be collectively used to determine the position and/or rotation of the user's eyes 715A, 715B over a wider range than either of the eye tracking systems 705A, 705B can achieve individually.

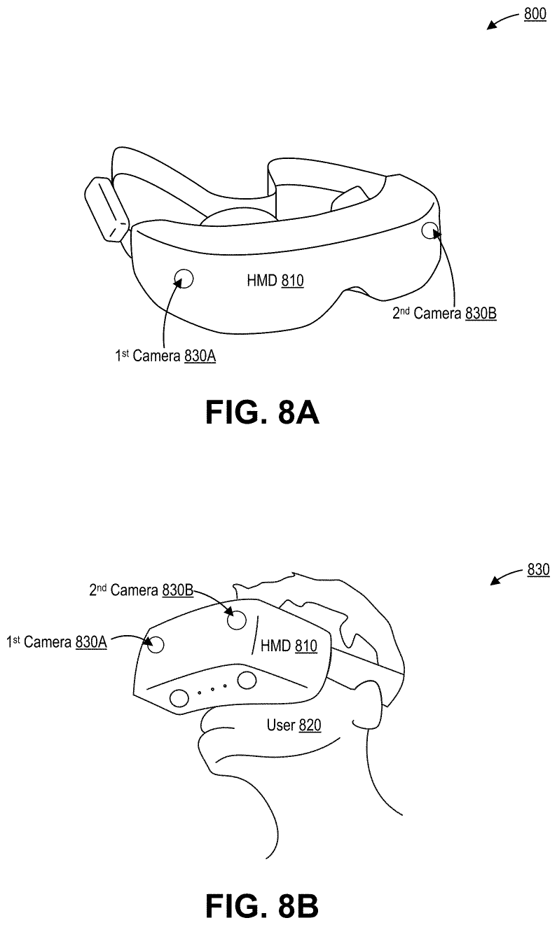

FIG. 8A is a perspective diagram 800 illustrating a head-mounted display (HMD) 810 that performs feature tracking and/or visual simultaneous localization and mapping (VSLAM), in accordance with some examples. The HMD 810 may be, for example, an augmented reality (AR) headset, a virtual reality (VR) headset, a mixed reality (MR) headset, an extended reality (XR) headset, or some combination thereof. The HMD 810 may be an example of an XR system 300. The HMD 810 includes a first camera 830A and a second camera 830B along a front portion of the HMD 810. The first camera 830A and the second camera 830B may be two environment facing image sensors of the one or more image sensors 302 of FIG. 3. In some examples, the HMD 810 may only have a single camera. In some examples, the HMD 810 may include one or more additional cameras in addition to the first camera 830A and the second camera 830B. For example, the HMD 810 may include one or more image sensors for eye tracking such as the image sensor 410 of FIGS. 4A and 4B, and/or image sensor 510 of FIGS. 5A and 5B. In some examples, the HMD 810 may include one or more additional sensors in addition to the first camera 830A and the second camera 830B.

FIG. 8B is a perspective diagram 830 illustrating the head-mounted display (HMD) 810 of FIG. 8A being worn by a user 820, in accordance with some examples. The user 820 wears the HMD 810 on the user 820's head over the user 820's eyes. The HMD 810 can capture images with the first camera 830A and the second camera 830B. In some examples, the HMD 810 displays one or more display images toward the user 820's eyes that are based on the images captured by the first camera 830A and the second camera 830B. The display images may provide a stereoscopic view of the environment, in some cases with information overlaid and/or with other modifications. For example, the HMD 810 can display a first display image to the user 820's right eye, the first display image based on an image captured by the first camera 830A. The HMD 810 can display a second display image to the user 820's left eye, the second display image based on an image captured by the second camera 830B. For instance, the HMD 810 may provide overlaid information in the display images overlaid over the images captured by the first camera 830A and the second camera 830B.

The HMD 810 includes no conveyance of its own. Instead, the HMD 810 relies on the movements of the user 820 to move the HMD 810 about the environment. Thus, in some cases, the HMD 810, when performing a SLAM technique, can skip path planning using a path planning engine and/or movement actuation using the movement actuator. In some cases, the HMD 810 can still perform path planning using a path planning engine and can indicate directions to follow a suggested path to the user 820 to direct the user along the suggested path planned using the path planning engine. In some cases, for instance where the HMD 810 is a VR headset, the environment may be entirely or partially virtual. If the environment is at least partially virtual, then movement through the virtual environment may be virtual as well. For instance, movement through the virtual environment can be controlled by an input device. The movement actuator may include any such input device. Movement through the virtual environment may not require wheels, propellers, legs, or any other form of conveyance. If the environment is a virtual environment, then the HMD 810 can still perform path planning using the path planning engine and/or movement actuation. If the environment is a virtual environment, the HMD 810 can perform movement actuation using the movement actuator by performing a virtual movement within the virtual environment. Even if an environment is virtual, SLAM techniques may still be valuable, as the virtual environment can be unmapped and/or may have been generated by a device other than the HMD 810, such as a remote server or console associated with a video game or video game platform. In some cases, feature tracking and/or SLAM may be performed in a virtual environment even by vehicle or other device that has its own physical conveyance system that allows it to physically move about a physical environment. For example, SLAM may be performed in a virtual environment to test whether a SLAM system is working properly without wasting time or energy on movement and without wearing out a physical conveyance system.

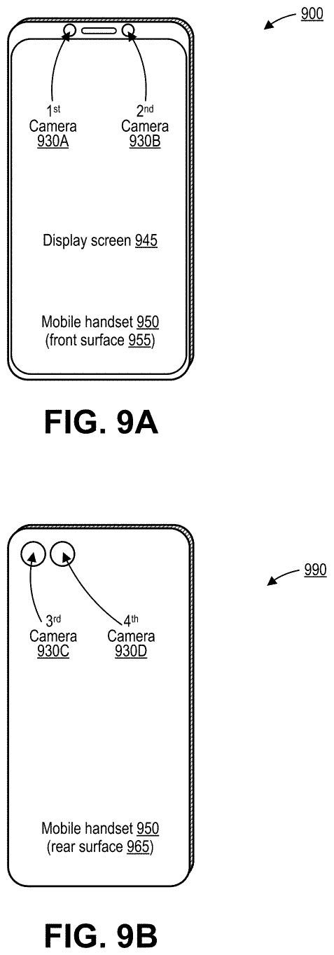

FIG. 9A is a perspective diagram 900 illustrating a front surface 955 of a mobile device 950 that performs feature tracking, gaze tracking and/or visual simultaneous localization and mapping (VSLAM) using one or more front-facing cameras 930A-B, in accordance with some examples. The mobile device 950 may be an example of an XR system 300. The mobile device 950 may be, for example, a cellular telephone, a satellite phone, a portable gaming console, a music player, a health tracking device, a wearable device, a wireless communication device, a laptop, a mobile device, any other type of computing device or computing system 1100 discussed herein, or a combination thereof. The front surface 955 of the mobile device 950 includes a display screen 945. The front surface 955 of the mobile device 950 includes a first camera 930A and a second camera 930B. The first camera 930A and the second camera 930B are illustrated in a bezel around the display screen 945 on the front surface 955 of the mobile device 950. In some examples, the first camera 930A and the second camera 930B can be positioned in a notch or cutout that is cut out from the display screen 945 on the front surface 955 of the mobile device 950. In some examples, the first camera 930A and the second camera 930B can be under-display cameras that are positioned between the display screen 945 and the rest of the mobile device 950, so that light passes through a portion of the display screen 945 before reaching the first camera 930A and the second camera 930B. The first camera 930A and the second camera 930B of the perspective diagram 900 are front-facing cameras. The first camera 930A and the second camera 930B face a direction perpendicular to a planar surface of the front surface 955 of the mobile device 950. The first camera 930A and the second camera 930B may be two of the one or more image sensors 302. The first camera 930A and the second camera 930B may be included in the one or more image sensors 302 of FIG. 3. In some examples, the front surface 955 of the mobile device 950 may only have a single camera. In some examples, the mobile device 950 may include one or more additional cameras in addition to the first camera 930A and the second camera 930B. In some examples, the mobile device 950 may include one or more additional sensors in addition to the first camera 930A and the second camera 930B.

FIG. 9B is a perspective diagram 990 illustrating a rear surface 965 of a mobile device 950 that performs feature tracking, gaze tracking and/or visual simultaneous localization and mapping (VSLAM) using one or more rear-facing cameras 930C-D, in accordance with some examples. The mobile device 950 includes a third camera 930C and a fourth camera 930D on the rear surface 965 of the mobile device 950. The third camera 930C and the fourth camera 930D of the perspective diagram 990 are rear-facing. The third camera 930C and the fourth camera 930D face a direction perpendicular to a planar surface of the rear surface 965 of the mobile device 950. While the rear surface 965 of the mobile device 950 does not have a display screen 945 as illustrated in the perspective diagram 990, in some examples, the rear surface 965 of the mobile device 950 may have a second display screen. If the rear surface 965 of the mobile device 950 has a display screen 945, any positioning of the third camera 930C and the fourth camera 930D relative to the display screen 945 may be used as discussed with respect to the first camera 930A and the second camera 930B at the front surface 955 of the mobile device 950. The third camera 930C and the fourth camera 930D may be two of the one or more image sensors 302 of FIG. 3. In some examples, the rear surface 965 of the mobile device 950 may only have a single camera. In some examples, the mobile device 950 may include one or more additional cameras in addition to the first camera 930A, the second camera 930B, the third camera 930C, and the fourth camera 930D. In some examples, the mobile device 950 may include one or more additional sensors in addition to the first camera 930A, the second camera 930B, the third camera 930C, and the fourth camera 930D.

Like the HMD 810, the mobile device 950 includes no wheels, propellers, or other conveyance of its own. Instead, the mobile device 950 relies on the movements of a user holding or wearing the mobile device 950 to move the mobile device 950 about the environment. Thus, in some cases, the mobile device 950, when performing a SLAM technique, can skip path planning using the path planning engine and/or movement actuation using the movement actuator. In some cases, the mobile device 950 can still perform path planning using the path planning engine, and can indicate directions to follow a suggested path to the user to direct the user along the suggested path planned using the path planning engine. In some cases, for instance where the mobile device 950 is used for AR, VR, MR, or XR, the environment may be entirely or partially virtual. In some cases, the mobile device 950 may be slotted into a head-mounted device (HMD) (e.g., into a cradle of the HMD) so that the mobile device 950 functions as a display of the HMD, with the display screen 945 of the mobile device 950 functioning as the display of the HMD. If the environment is at least partially virtual, then movement through the virtual environment may be virtual as well. For instance, movement through the virtual environment can be controlled by one or more joysticks, buttons, video game controllers, mice, keyboards, trackpads, and/or other input devices that are coupled in a wired or wireless fashion to the mobile device 950. The movement actuator may include any such input device. Movement through the virtual environment may not require wheels, propellers, legs, or any other form of conveyance. If the environment is a virtual environment, then the mobile device 950 can still perform path planning using the path planning engine and/or movement actuation. If the environment is a virtual environment, the mobile device 950 can perform movement actuation using the movement actuator by performing a virtual movement within the virtual environment.

As noted above, the systems and techniques described herein can be used to extend the range of position and/or rotation of a user's eyes that can be detected by an eye tracking system. The systems and techniques can extend the range of position and/or rotation detected by eye tracking by including two eye tracking systems including light directing components (e.g., light directing component 408 of FIGS. 4A and 4B) aligned to different axes. In some cases, the eye tracking systems can have larger effective imaging ranges along the axis of alignment of a corresponding light directing component. In some cases, images of the user's eyes may be out of range for a first eye tracking systems but in range for second eye tracking systems for some user eye positions and/or rotations. In some cases, images of the user's eyes may be out of range for the second eye tracking system but in range for the first eye tracking system. In some cases, by assuming that both of the user's eyes move together (e.g., when a virtual image is as a sufficient distance from the user's eyes), eye tracking data captured by either one or both of the eye tracking systems can be used to track both of the user's eyes, even if one of the eyes is actually outside of the range of one of the eye tracking systems. In some cases, eye tracking systems with light directing components aligned to different axes can be used to perform eye tracking on only one of a user's eyes with a similarly extended range, and the position and/or orientation of the other of the user's eyes can be determined based on the tracked eye's position.

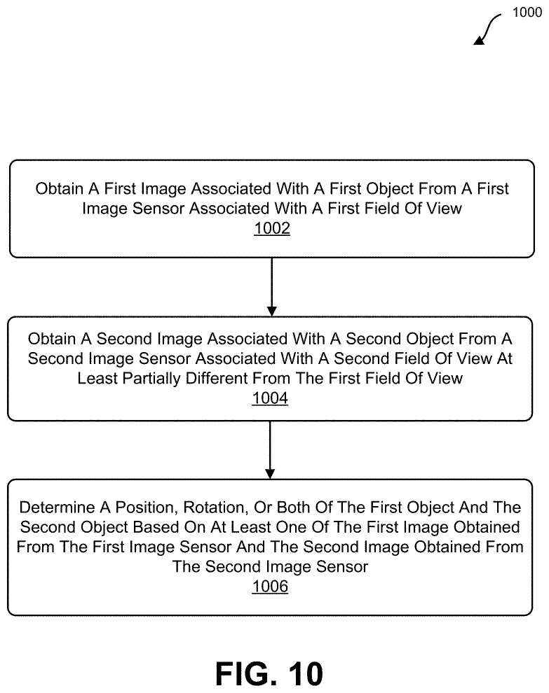

FIG. 10 is a flow diagram illustrating an example of a process 1000 for eye tracking. At block 1002, the process 1000 includes obtaining a first image associated with a first object from a first image sensor associated with a first field of view. In some examples, the first field of view is associated with a first illumination source, the first image sensor, and a first light directing component. In some cases, the first object is a first eye of a user and the second object is a second eye of the user. In some aspects, the first light directing component is disposed between the first object and a display and oriented along a first axis, wherein the first axis is parallel to a surface of a first lens facing the first object, the first lens included in a lens assembly. In examples, the first lens is included in a lens assembly and disposed between a display and the first object.

At block 1004, the process 1000 includes obtaining a second image associated with a second object from a second image sensor associated with a second field of view at least partially different from the first field of view. In some examples, the second field of view is associated with a second illumination source, the second image sensor, and a second light detecting component. In some cases, the second object is a second eye of the user. In some aspects, the second light directing component is disposed between the second object and the display and oriented along a second axis. In some cases, the second axis is parallel to a surface of a second lens facing the second object, and wherein an orientation of the first axis is different from an orientation of the second axis. In some examples, the second lens is included in the lens assembly and disposed between the display and the second object.

At block 1006, the process 1000 includes determining a position, rotation, or both of the first object and the second object based on at least one of the first image obtained from the first image sensor and the second image obtained from the second image sensor. In some examples, the position, rotation, or both of the first eye and the second eye are determined based on the first image obtained from the first image sensor. In some cases, the position, rotation, or both of the first eye and the second eye are determined based on the second image obtained from the second image sensor. In some examples, process 1000 includes determining the position, rotation, or both of the first eye and the second eye relative to a first axis based on the first image obtained from the first image sensor. In some cases, process 1000 includes determining the position, rotation, or both of the first eye and the second eye relative to a second axis, different from the first axis, based on the second image obtained form the second image sensor. In some aspects, the first axis is perpendicular to the second axis.

In some examples, the processes described herein (e.g., process 1000 and/or other process described herein) may be performed by a computing device or apparatus. In one example, one or more of the processes can be performed by the XR system 300 of FIG. 3. In another example, one or more of the processes can be performed by the computing system 1100 shown in FIG. 11. For instance, a computing device with the computing system 1100 shown in FIG. 11 can include the components of the eye tracking system included in compact lens assembly 400 of FIGS. 4A and 4B and can implement the operations of the process 1000 of FIG. 10 and/or other process described herein.

The computing device can include any suitable device, such as a vehicle or a computing device of a vehicle (e.g., a driver monitoring system (DMS) of a vehicle), a mobile device (e.g., a mobile phone), a desktop computing device, a tablet computing device, a wearable device (e.g., a VR headset, an AR headset, AR glasses, a network-connected watch or smartwatch, or other wearable device), a server computer, a robotic device, a television, and/or any other computing device with the resource capabilities to perform the processes described herein, including the process 1000 and/or other process described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 1000 is illustrated as a logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1000 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 11 is a diagram illustrating an example of a system for implementing certain aspects of the present technology. In particular, FIG. 11 illustrates an example of computing system 1100, which can be for example any computing device making up internal computing system, a remote computing system, a camera, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some embodiments, computing system 1100 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1100 includes at least one processing unit (CPU or processor) 1110 and connection 1105 that couples various system components including system memory 1115, such as read-only memory (ROM) 1120 and random access memory (RAM) 1125 to processor 1110. Computing system 1100 can include a cache 1112 of high-speed memory connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms. In some instances, multimodal systems can enable a user to provide multiple types of input/output to communicate with computing system 1100. Computing system 1100 can include communications interface 1140, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some embodiments, a hardware service that performs a particular function can include the software component stored in a computer-readable medium in connection with the necessary hardware components, such as processor 1110, connection 1105, output device 1135, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative Aspects of the Disclosure Include:

Aspect 1. An apparatus for eye tracking, comprising: a first plurality of eye tracking components comprising a first illumination source, a first image sensor, and a first light directing component associated with a first field of view; a second plurality of eye tracking components comprising a second illumination source, a second image sensor, and a second light directing component associated with a second field of view, wherein at least a portion of the first field of view is different from at least a portion of the second field of view; a display; and a lens assembly including a first lens between a first object and the display and a second lens between a second object and the display; wherein: the first light directing component is disposed between the first object and the display and oriented along a first axis, wherein the first axis is parallel to a surface of the first lens facing the first object; and the second light directing component is disposed between the second object and the display and oriented along a second axis, wherein the second axis is parallel to a surface of the second lens facing the second object, and wherein an orientation of the first axis is different from an orientation of the second axis.

Aspect 2. The apparatus of Aspect 1, wherein the first object is a first eye of a user and the second object is a second eye of the user.

Aspect 3. The apparatus of Aspect 2, wherein the first plurality of eye tracking components is associated with the first eye of the user and the second plurality of eye tracking components is associated with a second eye of the user.

Aspect 4. The apparatus of any of Aspects 2 to 3, wherein the first plurality of eye tracking components and the second plurality of eye tracking components are both associated with a same eye of the user.

Aspect 5. The apparatus of any of Aspects 2 to 4, wherein: the first light directing component comprises a first infrared (IR) reflecting surface and a first light guiding component configured to direct IR light from the first illumination source reflected by the first eye of the user to the first image sensor; and the second light directing component comprises a second IR reflecting surface and a second light guiding component configured to direct IR light from the second illumination source reflected by the second eye of the user to the second image sensor.

Aspect 6. The apparatus of any of Aspects 2 to 5, wherein one or more of the first IR reflecting surface and the second IR reflecting surface comprises a dielectric mirror.

Aspect 7. The apparatus of any of Aspects52 to 6, wherein one or more of the first IR reflecting surface and the second IR reflecting surface comprises a transparent conductor.

Aspect 8. The apparatus of any of Aspects 5 to 7, wherein the transparent conductor comprises indium-tin-oxide.

Aspect 9. The apparatus of any of Aspects 5 to 8, wherein the first IR reflecting surface and the first light guiding component are configured to direct light from the first field of view toward the first image sensor.

Aspect 10. The apparatus of any of Aspects 5 to 9, wherein the second IR reflecting surface and the second light guiding component are configured to direct light from the second field of view toward the second image sensor.

Aspect 11. The apparatus of any of Aspects 1 to 10, wherein the first axis is perpendicular to the second axis.

Aspect 12. The apparatus of Aspect 11, wherein the first axis is a vertical axis and the second axis is a horizontal axis relative to images displayed by the display.

Aspect 13. The apparatus of any of Aspects 1 to 12, wherein the first image sensor is configured to capture images of the first object while the second object is outside of the second field of view and the second image sensor is configured to capture images of the second object while the first object is outside of the first field of view.

Aspect 14. The apparatus of any of Aspects 1 to 13, further comprising: a memory; and one or more processors coupled to the memory and configured to determine a position, rotation, or both of a first eye and second eye of a user based on at least one of a first image obtained from the first image sensor and a second image obtained from the second image sensor.

Aspect 15. The apparatus of any of Aspects 1 to 14 further comprising: a memory; and one or more processors coupled to the memory and configured to obtain a first image from the first image sensor and determine a position, rotation, or both of a first eye and second eye of a user based on the first image.

Aspect 16. The apparatus of any of Aspects 1 to 15, further comprising: a memory; and one or more processors coupled to the memory and configured to obtain a second image from the second image sensor and determine a position, rotation, or both of a first eye and second eye of a user based on the second image.

Aspect 17. A method comprising: obtaining a first image associated with a first object from a first image sensor associated with a first field of view; obtaining a second image associated with a second object from a second image sensor associated with a second field of view at least partially different from the first field of view, and a second light directing component; and determining a position, rotation, or both of the first object and the second object based on at least one of the first image obtained from the first image sensor and the second image obtained from the second image sensor, wherein: the first field of view is associated with a first illumination source, the first image sensor, and a first light directing component; the first light directing component is disposed between the first object and a display and oriented along a first axis, wherein the first axis is parallel to a surface of a first lens facing the first object, the first lens included in a lens assembly; the second field of view is associated with a second illumination source, the second image sensor, and a second light directing component; the second light directing component is disposed between the second object and the display and oriented along a second axis, wherein the second axis is parallel to a surface of a second lens facing the second object, and wherein an orientation of the first axis is different from an orientation of the second axis; the first lens is included in a lens assembly and disposed between a display and the first object; and the second lens is included in the lens assembly disposed between the display and the second object.

Aspect 18. The method of Aspect 17, wherein the first object is a first eye of a user and the second object is a second eye of the user.

Aspect 19. The method of any of Aspect 18, wherein the position, rotation, or both of the first eye and the second eye are determined based on the first image obtained from the first image sensor.

Aspect 20. The method of any of Aspects 18 to 21, wherein the position, rotation, or both of the first eye and the second eye are determined based on the second image obtained from the second image sensor.

Aspect 21. The method of any of Aspects 18 to 22, further comprising: determining the position, rotation, or both of the first eye and the second eye relative to a first axis based on the first image obtained from the first image sensor; and determining the position, rotation, or both of the first eye and the second eye relative to a second axis, different from the first axis, based on the second image obtained form the second image sensor.

Aspect 22. The method of any of Aspects 18 to 21, wherein the first axis is perpendicular to the second axis.

Aspect 23: A non-transitory computer-readable storage medium having stored thereon instructions which, when executed by one or more processors, cause the one or more processors to perform any of the operations of aspects 1 to 22.

Aspect 24: An apparatus comprising means for performing any of the operations of aspects 1 to 22.

What is claimed is:

1. An apparatus for eye tracking, comprising:
a first plurality of eye tracking components comprising a first illumination source, a first image sensor, and a first light directing component associated with a first field of view;
a second plurality of eye tracking components comprising a second illumination source, a second image sensor, and a second light directing component associated with a second field of view, wherein at least a portion of the first field of view is different from at least a portion of the second field of view;
a display; and
a lens assembly including a first lens between a first object and the display and a second lens between a second object and the display;
wherein:
the first light directing component is disposed between the first object and the display and oriented along a first axis, wherein the first axis is parallel to a surface of the first lens facing the first object; and
the second light directing component is disposed between the second object and the display and oriented along a second axis, wherein the second axis is parallel to a surface of the second lens facing the second object, and wherein an orientation of the first axis is different from an orientation of the second axis.

2. The apparatus of claim 1, wherein the first object is a first eye of a user and the second object is a second eye of the user.

3. The apparatus of claim 2, wherein the first plurality of eye tracking components is associated with the first eye of the user and the second plurality of eye tracking components is associated with a second eye of the user.

4. The apparatus of claim 2, wherein the first plurality of eye tracking components and the second plurality of eye tracking components are both associated with a same eye of the user.

5. The apparatus of claim 2, wherein:
the first light directing component comprises a first infrared (IR) reflecting surface and a first light guiding component configured to direct IR light from the first illumination source reflected by the first eye of the user to the first image sensor; and
the second light directing component comprises a second IR reflecting surface and a second light guiding component configured to direct IR light from the second illumination source reflected by the second eye of the user to the second image sensor.

6. The apparatus of claim 5, wherein one or more of the first IR reflecting surface and the second IR reflecting surface comprises a dielectric mirror.

7. The apparatus of claim 5, wherein one or more of the first IR reflecting surface and the second IR reflecting surface comprises a transparent conductor.

8. The apparatus of claim 7, wherein the transparent conductor comprises indium-tin-oxide.

9. The apparatus of claim 5, wherein the first IR reflecting surface and the first light guiding component are configured to direct light from the first field of view toward the first image sensor.

10. The apparatus of claim 9, wherein the second IR reflecting surface and the second light guiding component are configured to direct light from the second field of view toward the second image sensor.

11. The apparatus of claim 1, wherein the first axis is perpendicular to the second axis.

12. The apparatus of claim 11, wherein the first axis is a vertical axis and the second axis is a horizontal axis relative to images displayed by the display.

13. The apparatus of claim 1, wherein the first image sensor is configured to capture images of the first object while the second object is outside of the second field of view and the second image sensor is configured to capture images of the second object while the first object is outside of the first field of view.

14. The apparatus of claim 1, further comprising:
a memory; and
one or more processors coupled to the memory and configured to determine a position, rotation, or both of a first eye and second eye of a user based on at least one of a first image obtained from the first image sensor and a second image obtained from the second image sensor.

15. The apparatus of claim 1 further comprising:
a memory; and
one or more processors coupled to the memory and configured to obtain a first image from the first image sensor and determine a position, rotation, or both of a first eye and second eye of a user based on the first image.

16. The apparatus of claim 1, further comprising:
a memory; and
one or more processors coupled to the memory and configured to obtain a second image from the second image sensor and determine a position, rotation, or both of a first eye and second eye of a user based on the second image.

17. A method comprising:
obtaining a first image associated with a first object from a first image sensor associated with a first field of view, wherein the first field of view is associated with a first illumination source, the first image sensor, and a first light directing component;
obtaining a second image associated with a second object from a second image sensor associated with a second field of view at least partially different from the first field of view; and
determining a position, rotation, or both of the first object and the second object based on at least one of the first image obtained from the first image sensor and the second image obtained from the second image sensor, wherein:
the first field of view is associated with a first illumination source, the first image sensor, and a first light directing component;
the first light directing component is disposed between the first object and a display and oriented along a first axis, wherein the first axis is parallel to a surface of a first lens facing the first object, the first lens included in a lens assembly;
the second field of view is associated with a second illumination source, the second image sensor, and a second light directing component;
the second light directing component is disposed between the second object and the display and oriented along a second axis, wherein the second axis is parallel to a surface of a second lens facing the second object, and wherein an orientation of the first axis is different from an orientation of the second axis;
the first lens is included in a lens assembly and disposed between a display and the first object; and
the second lens is included in the lens assembly and disposed between the display and the second object.

18. The method of claim 17, wherein the first object is a first eye of a user and the second object is a second eye of the user.

19. The method of claim 18, wherein the position, rotation, or both of the first eye and the second eye are determined based on the first image obtained from the first image sensor.

20. The method of claim 18, wherein the position, rotation, or both of the first eye and the second eye are determined based on the second image obtained from the second image sensor.

21. The method of claim 18, further comprising:
determining the position, rotation, or both of the first eye and the second eye relative to a first axis based on the first image obtained from the first image sensor; and
determining the position, rotation, or both of the first eye and the second eye relative to a second axis, different from the first axis, based on the second image obtained form the second image sensor.

22. The method of claim 21, wherein the first axis is perpendicular to the second axis.
